(19) United States
(12) Patent Application Publication
(10) Pub. No.: US 2005/0215289 A1
(43) Pub. Date: Sep. 29, 2005

(54) Apparatus and method for dynamic control of downlink beam width of an adaptive antenna array in a wireless network

(75) Inventors: Cornelius van Rensburg, Dallas, TX (US); Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/811,432

(22) Filed: Mar. 26, 2004

(51) Int. Cl. H04M 1/00; H04B 1/38

(52) U.S. Cl. 455/562.1; 455/561

(57) ABSTRACT

A wireless network base station for optimizing the beam width of a downlink traffic beam in real time is provided. The base station includes a transceiver for receiving a pilot strength signal and a power control signal from a mobile station. The base station further includes beam forming circuitry operable to form a downlink traffic beam spatially directed to serve the mobile station having a beam width set as a function of the received pilot strength signal and power control signal.

### TECHNICAL FIELD OF THE INVENTION

The present invention is directed generally to wireless networks and, more specifically, to a technique for dynamically adjusting an adaptive antenna array to select an optimum beam width for transmitting in a wireless network.

### BACKGROUND OF THE INVENTION

Wireless communication systems have become ubiquitous in society. Business and consumers use a wide variety of fixed and mobile wireless terminals, including cell phones, pagers, Personal Communication Services (PCS) systems, and fixed wireless access devices (i.e., vending machine with cellular capability). Wireless service providers continually try to create new markets for wireless devices and expand existing markets by making wireless devices and services cheaper and more reliable.

In code division multiple access (CDMA) networks, for example, adaptive antenna arrays have been developed to increase the capacity and quality of calls handled within CDMA networks. Adaptive antenna arrays utilize “beam forming” techniques to provide directional antenna beams in the downlink from the base station to the wireless terminal. For example, angle of arrival (AOA) information determined from a received signal at an adaptive antenna array may be used to determine beam forming coefficients for use in providing a narrow beam spatially directed to a specific wireless terminal in the downlink to provide improved capacity and quality. The narrow beam carries a traffic signal intended for the specific wireless terminal.

However, the use of narrow beams introduces a new problem in the communication downlink. In CDMA networks, the traffic signal is demodulated by individual wireless terminals using a common pilot signal received by all wireless terminals in a sector or cell served by the base station. Thus, the common pilot signal is carried on a wide beam transmitted throughout the cell or sector of the base station. Since the downlink channel associated with the pilot signal (e.g., wide beam) is different from the downlink channel associated with the traffic signal (e.g., narrow beam), the phase information extracted from the pilot signal may not accurately correlate with the traffic signal.

To compensate for the phase mismatch, various beam optimizing techniques have been proposed. For example, in published U.S. patent application Ser. No. 2002/0146983 to Scherzer et al. (hereinafter, Scherzer), a base station service area is divided into segments and optimized beam widths for each segment are pre-calculated during a learning or calibration phase and stored in a table. During normal operation, the segment within which a wireless terminal is located is identified, and the optimized beam width for that segment is determined using a look-up operation in the table. In another embodiment of Scherzer, the beam width is calculated as an inverse function of the frame error rate as measured by the wireless terminal.

However, pre-calculating the beam forming coefficients for each segment is an inflexible solution that does not correct the phase mismatch equally across all areas of each segment. In addition, a pre-calculated look-up table assumes a static physical environment, which is unrealistic in many urban areas. Furthermore, the learning or calibration phase is a time consuming and computation intensive process. Likewise, using the FER to calculate the beam width also involves lengthy computations, which can lead to a suboptimal choice of beam width.

Therefore, there is a need in the art for an improved downlink beam width optimizing system and method that is more flexible, accurate and robust. In particular, there is a need for a base station that is capable of forming a narrow beam having an optimal beam width in real time.

### SUMMARY OF THE INVENTION

The present invention provides a technique to optimize the beam width of a downlink traffic beam in real time. In particular, the present invention uses a pilot strength signal and power control signal received from a mobile station in determining the optimum beam width for a downlink traffic beam spatially directed to serve the mobile station.

To address the above-discussed deficiencies of the prior art, it is a primary object of the present invention to provide, for use in a wireless network, a base station capable of optimizing the beam width of a downlink traffic beam. According to an advantageous embodiment of the present invention, the base station comprises: (i) a transceiver capable of receiving a pilot strength signal and power control signal from a select mobile station; and (ii) beam forming circuitry capable of forming a downlink traffic beam spatially directed to serve the select mobile station, in which the downlink traffic beam has a beam width set as a function of the pilot strength signal and the power control signal.

According to one embodiment of the present invention, the base station further comprises an adaptive antenna array capable of facilitating the forming of the downlink beam by the beam forming circuitry.

According to another embodiment of the present invention, the base station is further capable of transmitting a pilot signal on a pilot beam for use by multiple mobile stations. The pilot strength signal is generated by the select mobile station in response to the received pilot signal to report the signal strength of the received pilot signal.

According to still another embodiment of the present invention, the traffic beam carries a traffic signal associated with the select mobile station. The power control signal is generated by the select mobile station in response to the received traffic signal to request the base station to increase or decrease the power of the traffic signal.

According to yet another embodiment of the present invention, the base station is further capable of receiving a first pilot strength signal and a second pilot strength signal over a beam update time and multiple power control signals during the beam update time. The base station is capable of calculating a differential pilot strength corresponding to a difference between a value of the first pilot strength signal and a value of the second pilot strength signal and a differential power control.

According to a further embodiment of the present invention, the base station is further capable of decreasing the beam width of the traffic beam when the differential power control is equal to 0 or −1, increasing the beam width of said traffic beam when the differential power control is equal to +1 and the differential pilot strength is equal to +1 and decreasing the beam width of said traffic beam when the differential power control is equal to +1 and the differential pilot strength is equal to 0 or −1.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which beam widths are optimized according to an exemplary embodiment of the present invention;

FIG. 2 illustrates a base station providing downlink beams which may be optimized according to an exemplary embodiment of the present invention;

FIG. 3 illustrates the base station in greater detail having the ability to optimize the beam width of downlink beams according to an exemplary embodiment of the present invention; and

FIG. 4 is a flow diagram illustrating a beam width optimizing process according to an exemplary embodiment of the present invention.

### DETAILED DESCRIPTION OF THE INVENTION

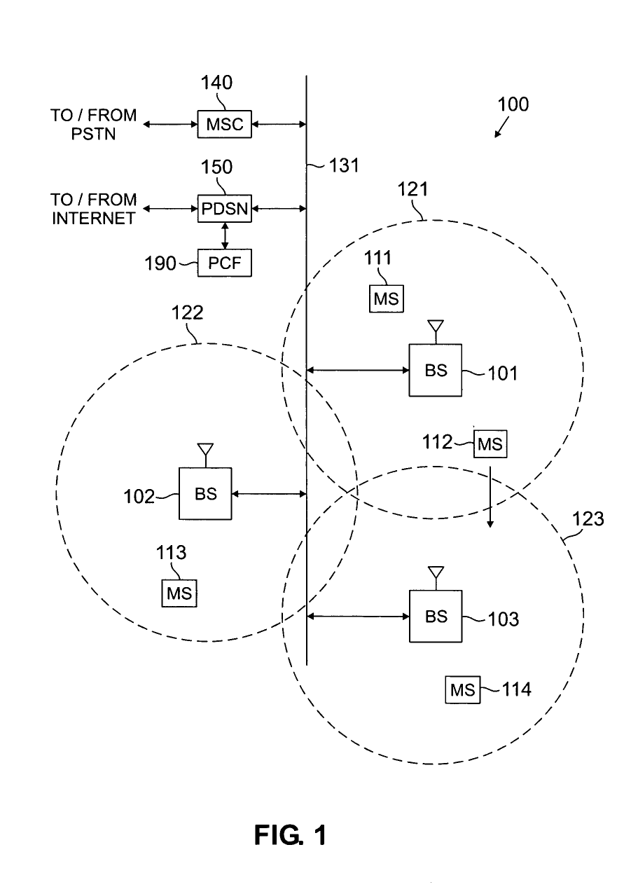

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, in which beam widths are optimized according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000-C standard (i.e., Release C of cdma2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

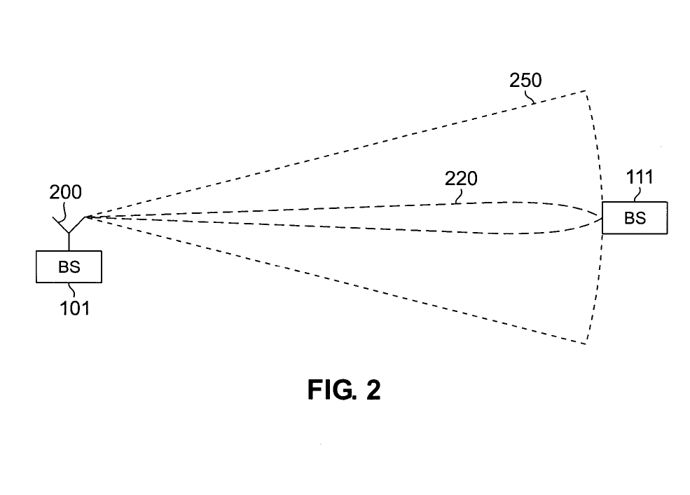

FIG. 2 illustrates a base station 101 providing downlink beams which may be optimized according to an exemplary embodiment of the present invention. BS 101 includes adaptive antenna array 200 having antenna elements (not shown) disposed in a predetermined geometry for use in beam forming, as is well known in the art. BS 101 is shown in communication with MS 111. In preferred embodiments, BS 101 and MS 111 operate to provide wireless communication services according to the CDMA-2000 protocol. However, it should be understood that the present invention is not limited to the CDMA-2000 protocol, but instead can be applied to any communication protocol in which directional traffic signals are formed using adaptive antenna arrays.

According to the CDMA-2000 protocol, each MS 111 transmits a traffic signal and a unique pilot signal associated with the MS 111 to the BS 101 on the uplink. On the downlink, BS 101 transmits a traffic signal unique to each MS 111 and a common pilot signal to all of the MS's 111 within a sector or cell served by BS 101. The traffic signal is carried on traffic beam 220 spatially directed to MS 111, and the common pilot signal is carried on pilot beam 250 radiated throughout an area (e.g., sector or cell) served by BS 101. Thus, pilot beam 250 has a beam width substantially wider than traffic beam 220. The pilot signal carried on pilot beam 250 is used by MS 111 to demodulate the traffic signal carried on traffic beam 220.

BS 101 forms traffic beam 220 based on the location of MS 111, as determined from various uplink channel information, such as the Angle of Arrival (AOA) and/or Time of Arrival (TOA) of signals transmitted from MS 111 to BS 101. From the MS 111 location, BS 101 calculates beam forming coefficients associated with signals of various antenna elements of antenna array 200 for use in forming a narrow beam (traffic beam 220) spatially directed to MS 111. The beam forming coefficients define various beam forming attributes of traffic beam 220. For example, the beam forming coefficients may define the beam width, orientation (azimuth and elevation) and power of traffic beam 220.

MS 111 reports the channel characteristics of the downlink channel to BS 101 in a pilot strength signal (e.g., a Pilot Strength Measurement Message (PSMM) or the Power Measurement Report Message (PMRM)). Both PSMM and PMRM inform BS 101 of the signal strength of the pilot signal as received by MS 111, and may be used by BS 101 in determining the location of MS 111. MS 111 requests BS 101 to increase or decrease the Digital Gain Unit (DGU) power of the downlink traffic signal by sending the DGU increase or DGU decrease in a power control message (e.g., a Power Control Group (PCG) message). The PSMM could typically be received by BS 101 every 100 ms, corresponding to the beam update period, while the PCG is typically received by BS 101 every 1.25 ms.

Normally, an inverse relationship exists between the pilot signal strength and the PCG. Thus, if the pilot signal strength increases (e.g., due to movement of MS 111 closer to BS 101), the PCG requests a decrease in power of the traffic signal. Likewise, if the pilot signal strength decreases (e.g., due to movement of MS 111 away from BS 101), the PCG requests an increase in power of the traffic signal. Therefore, BS 101 in a conventional structure only relies on the PCG and the frame error rate (FER) in order to determine the transmit power of the traffic signal.

However, when using an adaptive antenna array 200 with narrow traffic beams 220, the angle spread (the spread of angles from which a signal is received due to channel characteristics, such as scattering zones, multi-path conditions, etc.) of the narrow traffic beam 220 may differ from the angle spread of the wide pilot beam 250, which can result in a phase mismatch between the traffic signal and the pilot signal. As a result, the MS 111 may report in a PCG that requests an increase in power, without reporting a corresponding decrease in the pilot signal strength. In this situation, rather than increasing the transmit power of the traffic signal, the phase mismatch can be reduced by increasing the beam width (+BW) of traffic beam 220, in accordance with embodiments of the present invention.

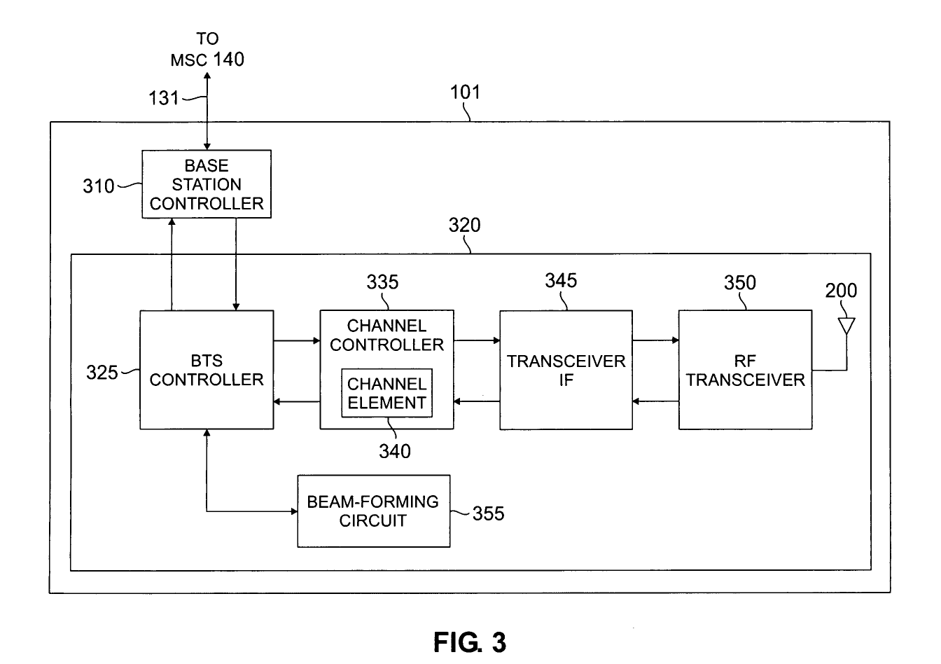

FIG. 3 illustrates the base station (BS) 101 in greater detail having the ability to optimize the beam width of downlink beams according to an exemplary embodiment of the present invention. Base station 101 comprises base station controller (BSC) 310 and base transceiver station (BTS) 320. Base station controllers and base transceiver stations were described previously in connection with FIG. 1. BSC 310 manages the resources in cell site 121, including BTS 320. BTS 320 comprises BTS controller 325, channel controller 335 (which contains representative channel element 340), transceiver interface (IF) 345, RF transceiver unit 350, adaptive antenna array 200, and beam forming circuitry 355.

BTS controller 325 comprises processing circuitry and memory capable of executing an operating program that controls the overall operation of BTS 320 and communicates with BSC 310. Under normal conditions, BTS controller 325 communicates with beam forming circuitry 355 to direct the operation of channel controller 335, which contains a number of channel elements, including channel element 340, that perform bi-directional communications in the forward (downlink) channel and the reverse (uplink) channel. Transceiver IF 345 transfers the bi-directional channel signals between channel controller 340 and RF transceiver unit 350.

Adaptive antenna array 200 transmits forward channel signals received from RF transceiver unit 350 to mobile stations in the coverage area of BS 101. Adaptive antenna array 200 also sends to transceiver 350 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area and each antenna includes multiple antenna elements for beam forming, as shown in FIG. 2. Additionally, transceiver 350 may contain an antenna selection unit to select among different antennas and antenna elements in antenna array 200 during both transmit and receive operations.

Transceiver 350 receives a PSMM including the received pilot signal strength (PS) and a PCG including the requested DGU from each mobile station currently being served by BS 101. Transceiver 350 forward the PS and PCG to beam forming circuitry 355 to determine various beam forming attributes, including the beam width, of each narrow traffic beam transmitted on the downlink. Since the PSMM is received typically every 100 ms, while the PCG is received every 1.25 msec, in order to compare the PS with the requested DGU, beam forming circuitry 355 compares the cumulated DGU movement over the beam update time period to the differential value of the PS, as follows:
dPS(t₁)=sign{PS(t₁)−PS(t₀)}, and
dDGU(t₁)=sign{sum over all power control periods from t₀ to t₁}, or alternatively,
dDGU(t₁)=sign{DGU_{—}Tx_Power(t₁)−DGU_{—}Tx_Power(t₀)}.

As discussed above, normally, an inverse relationship exists between dPS and dDGU. However, when using an adaptive antenna array 200, it is possible to have a phase mismatch between the forward traffic channel and the forward pilot channel, in which case the mobile station would report a dDGU>0 and a dPS=0. In this situation, rather than increasing the transmit power of the traffic signal, the phase mismatch can be reduced by increasing the beam width (+BW) of the traffic beam. In general, beam forming circuitry 355 can modify the beam width (BW) of the traffic beam for a particular mobile station using the following algorithms:
If dDGU=0 or −1, then decrease BW (−BW).
If dDGU=+1 and dPS=+1, then increase BW (+BW), else decrease BW (−BW).

Specifically, consider a forward link traffic beam wₜ, a pilot beam wₚ, a fading channel a and steering vector v(θ). The received traffic signal at the mobile station can be represented by: r=Wₜ^{H}as+n, where n is the AWGN process. Since a(t)=Σᵢ v(θᵢ) α(θᵢ), where α(θᵢ) is the complex Rayleigh fading, the covariance can be defined as: R=E[aa^{H}]=Σᵢ v(θᵢ) p(θᵢ) v^{H} (θᵢ), where p(θᵢ) is the probability that the scattering region will include angle θᵢ. The term “E[]” means the statistical expected value inside the brackets. Typically, p(θᵢ) is chosen as a normal distribution with standard deviation of 20 degrees. In order to consider errors in manifold measurements, diagonal loading can be used, namely R=R+δI, where δ is the percentage manifold error tolerated, typically 10%.

Transceiver 350 implements an MRC detector where the estimated channel is the pilot channel. Thus, the detector statistic is: wₜ^{H}aa^{H}wₚ, which is a function of the phase mismatch between the pilot and the traffic channel: Φ(t)=phase{wₜ^{H}a(t)a^{H}(t)wₚ}. It is thus necessary to choose wₜ such that the phase mismatch Φ is acceptable for the particular modulation scheme, as follows: maximize wₜ^{H}Rwₜ/wₜ^{H}wₜ, subject to ||wₜ||²=1.

A well known solution to the maximization problem is to choose wₜ as the eigenvector corresponding to the largest eigenvalue of R. However, the traffic beam would not be matched to the pilot beam. To match the traffic beam to the pilot beam, components of the pilot are added in until the pilot beam and the traffic beam are matched. A traffic beam can be calculated as follows:

For a given channel covariance matrix R with the matrix of eigenvectors G=[g₁ g₂ g₃ g₄] corresponding to the eigenvalues [λ₁ λ₂ λ₃ λ₄], where λ₁>λ₂>λ₃>λ₄, and given an adaption rate of 0<μ<1, [g₁^{H}wₚg₁ μg₂^{H}wₚg₂ μg₃^{H}wₚg₃ μg₄^{H}wₚg₄] is generated in a table format. It should be noted that a larger μ will generate a phase matched beam quicker, but the beam will be less optimum (less gain).

In operation, at call set-up, beam forming circuitry 355 calculates an initial value of wₜ=g₁^{H}wₚg₁, where wₜ is the narrowest beam, wₚ is the widest beam, and i=2, n=0. Each time a PSMM message is received, beam forming circuitry 355 executes the following algorithms:
If {n>1/μ, and (+BW) and i<4}, then set {i=i+1; n=0, wₜ(t+1)=wₜ(t)+μgᵢ^{H}wₚgᵢ, n=n+1}.
If {n>1/μ, and (+BW) and i<=4}, then set {wₜ(t+1)=wₜ(t)+μgᵢ^{H}wₚgᵢ, n=n+1}.
If {n=0, and (−BW) and i>2} then set {i=i−1; n=1/μ; wₜ(t+1)=wₜ(t)−μgᵢ^{H}wₚgᵢ, n=n−1}.
If {n>0, and (−BW) and i>=2} then set {wₜ(t+1)=wₜ(t)−μgᵢ^{H}wₚgᵢ, n=n−1}.

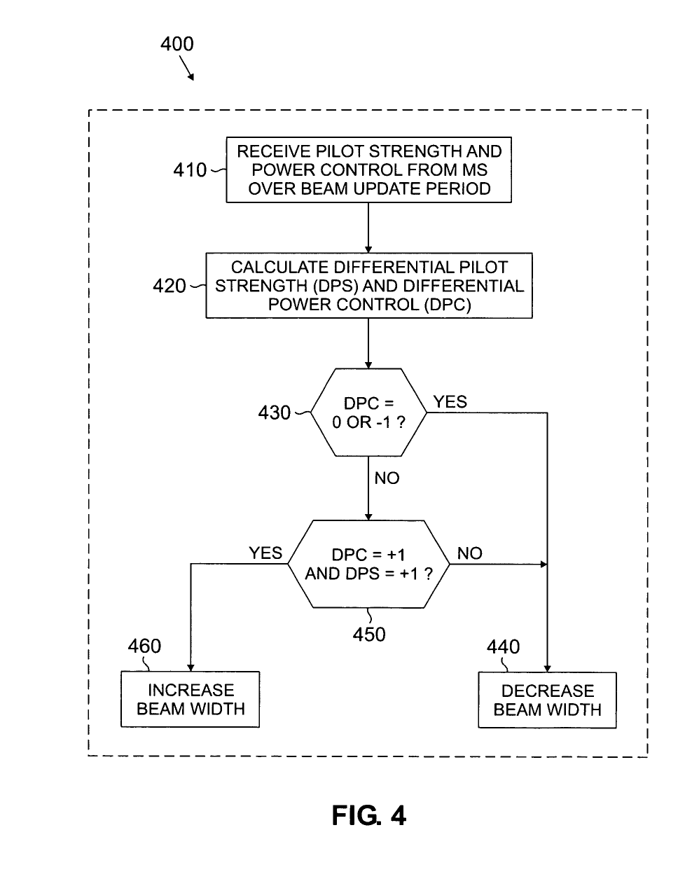

FIG. 4 is a flow diagram 400 illustrating a beam width optimizing process according to an exemplary embodiment of the present invention. Initially, BS 101 receives pilot strength signals (e.g., PSMM) and power control signals (e.g., PCG) from MS 111 over a beam update period (process step 410). Thereafter, BS 101 calculates the differential pilot strength (DPS) and differential power control (DPC) over the beam update period (process step 420). If DPC is equal to 0 or −1 (decision step 430), indicating that MS 111 is requesting the power of the traffic signal remain the same or be decreased, BS 101 decreases the beam width (-BW) of the traffic beam spatially directed to serve MS 111 (process step 440 from Y branch of decision step 430). Decreasing the beam width has the effect of decreasing the power in the received traffic signal.

However, if DPC is equal to +1, indicating that MS 111 is requesting the power of the traffic signal be increased, BS 101 determines the value of DPS. If both DPC and DPS are equal to +1, indicating a phase mismatch between the traffic signal and the pilot signal, (decision step 450 from N branch of decision step 430), BS 101 increases the beam width (+BW) of the traffic beam spatially directed to serve MS 111 to correct the phase mismatch (process step 440 from Y branch of decision step 450). However, if DPC is equal to +1 and DPS is equal to 0 or −1, BS 101 decreases the beam width (−BW) of the traffic beam spatially directed to serve MS 111 (process step 440 from N branch of decision step 450).

Although the present invention has been described with an exemplary embodiment, various changes and modifications may be suggested to one skilled in the art. It is intended that the present invention encompass such changes and modifications as fall within the scope of the appended claims.

1. For use in a wireless network, a base station capable of serving multiple mobile stations, said base station comprising:
a transceiver operable to receive from a select one of the multiple mobile stations a pilot strength signal and a power control signal; and
beam forming circuitry operable to form a downlink traffic beam spatially directed to serve said select one of said multiple mobile stations, said downlink traffic beam having a beam width set as a function of said pilot strength signal and said power control signal.

2. The base station as set forth in claim 1 further comprising an adaptive antenna array connected to said beam forming circuitry to facilitate forming of said downlink beam by said beam forming circuitry.

3. The base station as set forth in claim 1 wherein said beam forming circuitry comprises traffic beam forming circuitry operable to form said downlink traffic beam and pilot beam forming circuitry operable to form a pilot beam serving said multiple mobile stations.

4. The base station as set forth in claim 3 wherein said pilot beam has a beam width wider than said beam width of said traffic beam.

5. The base station as set forth in claim 3 wherein said pilot beam carries a pilot signal for use by said multiple mobile stations, said pilot strength signal being generated by said select one of said multiple mobile stations in response to said pilot signal received by said select one of said multiple mobile stations.

6. The base station as set forth in claim 3 wherein said traffic beam carries a traffic signal associated with said select one of said multiple mobile stations, said power control signal being generated by said select one of said multiple mobile stations in response to said traffic signal received by said select one of said multiple mobile stations.

7. The base station as set forth in claim 6 wherein said power control signal requests said base station to increase or decrease the power of said traffic signal.

8. The base station as set forth in claim 1 wherein said power control signal comprises a digital gain unit.

9. The base station as set forth in claim 1 wherein said transceiver is further operable to receive a first pilot strength signal and a second pilot strength signal over a beam update time and multiple power control signals during said beam update time.

10. The base station as set forth in claim 9 wherein said multiple power control signals are received every 1.25 msec and wherein said beam update time is 100 msec.

11. The base station as set forth in claim 9 wherein beam forming circuitry is further operable to calculate a differential pilot strength corresponding to a difference between a value of said first pilot strength signal and a value of said second pilot strength signal and a differential power control.

12. The base station as set forth in claim 11 wherein said differential power control comprises a cumulative value of said power control signal over said beam update time.

13. The base station as set forth in claim 11 wherein said differential power control corresponds to a difference between a value of said power control signal at a first time in said beam update time and a value of said power control signal at a second time in said beam update time.

14. The base station as set forth in claim 11 wherein beam forming circuitry is further operable to decrease the beam width of said traffic beam when said differential power control is equal to 0 or −1.

15. The base station as set forth in claim 11 wherein said beam forming circuitry is further operable to increase the beam width of said traffic beam when said differential power control is equal to +1 and said differential pilot strength is equal to +1 and decrease the beam width of said traffic beam when said differential power control is equal to +1 and said differential pilot strength is equal to 0 or −1.

16. A wireless network comprising a plurality of base stations, each one of said base stations capable of serving multiple mobile stations, said each base station comprising:
a transceiver operable to receive from a select one of the multiple mobile stations a pilot strength signal and a power control signal; and
beam forming circuitry operable to form a downlink traffic beam spatially directed to serve said select one of said multiple mobile stations, said downlink traffic beam having a beam width set as a function of said pilot strength signal and said power control signal.

17. The wireless network as set forth in claim 16 wherein each said base station further comprises an adaptive antenna array connected to said beam forming circuitry to facilitate forming of said downlink beam by said beam forming circuitry.

18. The wireless network as set forth in claim 16 wherein said beam forming circuitry comprises traffic beam forming circuitry operable to form said downlink traffic beam and pilot beam forming circuitry operable to form a pilot beam serving said respective multiple mobile stations.

19. The wireless network as set forth in claim 18 wherein said pilot beam has a beam width wider than said beam width of said traffic beam.

20. The wireless network as set forth in claim 18 wherein said pilot beam carries a pilot signal for use by said respective multiple mobile stations, said pilot strength signal being generated by said select one of said multiple mobile stations in response to said pilot signal received by said select one of said multiple mobile stations.

21. The wireless network as set forth in claim 18 wherein said traffic beam carries a traffic signal associated with said select one of said multiple mobile stations, said power control signal being generated by said select one of said multiple mobile stations in response to said traffic signal received by said select one of said multiple mobile stations.

22. The wireless network as set forth in claim 21 wherein said power control signal requests said respective base station to increase or decrease the power of said traffic signal.

23. The wireless network as set forth in claim 16 wherein said power control signal comprises a digital gain unit.

24. The wireless network as set forth in claim 16 wherein said transceiver is further operable to receive a first pilot strength signal and a second pilot strength signal over a beam update time and multiple power control signals during said beam update time.

25. The wireless network as set forth in claim 24 wherein said multiple power control signals are received every 1.25 msec and wherein said beam update time is 100 msec.

26. The wireless network as set forth in claim 24 wherein beam forming circuitry is further operable to calculate a differential pilot strength corresponding to a difference between a value of said first pilot strength signal and a value of said second pilot strength signal and a differential power control.

27. The wireless network as set forth in claim 26 wherein said differential power control comprises a cumulative value of said power control signal over said beam update time.

28. The wireless network as set forth in claim 26 wherein said differential power control corresponds to a difference between a value of said power control signal at a first time in said beam update time and a value of said power control signal at a second time in said beam update time.

29. The wireless network as set forth in claim 26 wherein beam forming circuitry is further operable to decrease the beam width of said traffic beam when said differential power control is equal to 0 or −1.

30. The wireless network as set forth in claim 26 wherein said beam forming circuitry is further operable to increase the beam width of said traffic beam when said differential power control is equal to +1 and said differential pilot strength is equal to +1 and decrease the beam width of said traffic beam when said differential power control is equal to +1 and said differential pilot strength is equal to 0 or −1.

31. For use in a base station capable of serving multiple mobile stations, a method of controlling the beam width of a downlink traffic beam spatially directed to serve a select one of said multiple mobile stations, the method comprising the steps of:
receiving from said select one of said multiple mobile stations a pilot strength signal and a power control signal; and
forming said downlink traffic beam with a beam width set as a function of said pilot strength signal and said power control signal.

32. The method as set forth in claim 31 wherein said forming further comprises using an adaptive antenna array to facilitate forming of said downlink beam.

33. The method as set forth in claim 31 further comprising forming a pilot beam carrying a pilot signal serving said multiple mobile stations, said pilot beam having a beam width wider than said beam width of said traffic beam.

34. The method as set forth in claim 33 wherein said receiving further comprises receiving said pilot strength signal generated by said select one of said multiple mobile stations in response to said pilot signal received by said select one of said multiple mobile stations.

35. The method as set forth in claim 31 wherein said receiving further comprises receiving said power control signal generated by said select one of said multiple mobile stations in response to a traffic signal carried by said traffic beam and received by said select one of said multiple mobile stations.

36. The method as set forth in claim 31 wherein said receiving further comprises receiving a first pilot strength signal and a second pilot strength signal over a beam update time and multiple power control signals during said beam update time.

37. The method as set forth in claim 36 wherein said forming further comprises calculating a differential pilot strength corresponding to a difference between a value of said first pilot strength signal and a value of said second pilot strength signal and calculating a differential power control.

38. The method as set forth in claim 37 wherein said calculating said differential power control further comprises calculating a cumulative value of said power control signal over said beam update time.

39. The method as set forth in claim 37 wherein said calculating said differential power control further comprises calculating a difference between a value of said power control signal at a first time in said beam update time and a value of said power control signal at a second time in said beam update time.

40. The method as set forth in claim 37 wherein said forming further comprises decreasing the beam width of said traffic beam when said differential power control is equal to 0 or −1.

41. The method as set forth in claim 37 wherein said forming further comprises:
increasing the beam width of said traffic beam when said differential power control is equal to +1 and said differential pilot strength is equal to +1; and
decreasing the beam width of said traffic beam when said differential power control is equal to +1 and said differential pilot strength is equal to 0 or −1.
